(19) United States
(12) Patent Application Publication
(10) Pub. No.: US 2026/0252845 A1
(43) Pub. Date: Aug. 27, 2026

(54) SYSTEMS AND METHODS FOR NEUROSYMBOLIC ROOT-CAUSE ANALYSIS AND RANKED TRIAGE

(71) Applicant: Arizona Board of Regents on Behalf of Arizona State University, Tempe, AZ (US)

(72) Inventor: Mukund Shenoy, Chandler, AZ (US)

(21) Appl. No.: 19/544,338

(22) Filed: Feb. 19, 2026

Related U.S. Application Data
(60) Provisional application No. 63/761,526, filed on Feb. 21, 2025.

(51) Int. Cl. G06N 3/042

(52) U.S. Cl. CPC G06N 3/042

(57) ABSTRACT

A system implements a hybrid AI framework which integrates symbolic reasoning with data-driven approaches to enhance defect prediction and risk management in semiconductor manufacturing. The framework combines rule-based logic and deep learning to handle multi-modal data from design, process, equipment, and material sources (such as FMEAs, specifications, metrology, and sensor data) and provides insights into hidden patterns in the data, identification of root causes for observed issues, and actionable outputs tailored to domain-specific requirements.

### CROSS REFERENCE TO RELATED APPLICATIONS

The present document is a Non-Provisional patent application that claims benefit to U.S. Provisional Patent Application Ser. No. 63/761,526 filed on Feb. 21, 2025, which is herein incorporated by reference in its entirety.

U.S. patent application Ser. No. 19/438,325, filed Dec. 31, 2025, which claims benefit to U.S. Provisional Patent Application Ser. No. 63/761,526 filed on Feb. 21, 2025, which is herein incorporated by reference in its entirety.

### FIELD

The present disclosure generally relates to computer-aided defect detection and diagnosis systems; and in particular, to a system and associated method for computer-aided defect diagnosis system that includes a neurosymbolic machine learning platform configured for auditable root-cause analysis and ranked triage in a semiconductor or other manufacturing process.

### BACKGROUND

Manufacturing quality excursions often present observable defect symptoms while the underlying causes are latent, distributed across stages, and only partially observed. For example, in surface-mount technology (SMT) assembly and semiconductor packaging, parameter deviations in solder paste printing and/or reflow can propagate to downstream defects such as solder bridging or open circuits. Production teams typically require rapid triage—i.e., a ranked set of plausible causal hypotheses—while also needing explanations that remain auditable for post-event review.

Existing approaches generally fall into two categories. First, data-driven predictors (e.g., neural networks) can output probabilities for defect occurrence, but commonly lack explicit causal structure and can be difficult to audit or justify. Second, rule-based or ontology-driven systems can provide deterministic, traceable causal explanations, but can be brittle under noisy, missing, or borderline evidence. Further, certain hybrid approaches entangle probabilistic inference directly into symbolic rule firing, complicating validation and eroding interpretability.

Accordingly, there is a need for improved diagnosis systems that (i) preserve deterministic, auditable causal reasoning over explicit causal structures, (ii) explicitly represent uncertainty without embedding probabilistic logic into symbolic rule execution, and (iii) generate ranked, actionable diagnostic outputs suitable for operational triage.

It is with these observations in mind, among others, that various aspects of the present disclosure were conceived and developed.

### SUMMARY

The present disclosure provides a number of examples that describe computer-implemented neurosymbolic techniques and operations for detecting defects including root-cause analysis (RCA), diagnosis, and decision support in manufacturing environments in a manufacturing process. In the context of the disclosed methods, devices, techniques, apparatus, systems, and so on, the terms “operable to,” “configured to,” and “capable of” used herein are interchangeable.

The present inventive concept includes various technical improvements and solutions, including but not limited to the following components:
A two-layer, strictly decoupled neurosymbolic pipeline that produces ranked defect-mechanism-parameter-violation hypotheses for surface-mount assembly RCA from uncertain observations.
A stage-wise multi-head multi-layer perceptron (MLP) evidence model that outputs defect and per-stage mechanism likelihoods and per-parameter risk scores, with controlled post-processing and/or configurable hypothesis selection/bounding (argmax selection and thresholding) that bounds hypothesis enumeration and avoids combinatorial explosion.
A provenance-linked conformance assessment evidence object that binds probability to measurement context and provenance metadata and is attached to instantiated semantic individuals, enabling auditable ranking without embedding probabilistic logic into the rule base. Stated another way, the provenance-linked conformance assessment evidence object, or simply, evidence object, binds a probabilistic value or confidence score to measurement context and specification context, and includes provenance metadata, and is attached to instantiated semantic individuals, enabling auditable ranking without embedding probabilistic logic into the rule base.
An end-to-end evaluation design using synthetic multi-shift data with correlated variation and graded ground truth, reporting set-level root-cause agreement (hit rate, Jaccard similarity, exact match), triage behavior (mean reciprocal rank), and edge-level chain fidelity with a cycle sanity check.

In illustrative embodiments, a neural evidence layer produces probabilistic evidence signals from per-unit manufacturing observations, including (i) a defect probability distribution, (ii) stage-wise mechanism probability distributions, and (iii) per-parameter risk probabilities. A deterministic semantic reasoning layer instantiates and/or updates an ontology-backed knowledge graph representing domain entities (e.g., products, stages, parameters, defects) and permitted cause-effect relations, and composes causal chains that connect a defect to one or more candidate causes.

A key design principle is a strict separation between uncertainty handling and causal reasoning. Probabilistic outputs from the neural evidence layer are materialized as provenance-linked evidence objects (also referred to herein as conformance-assessment evidence objects) that bind probability values to (a) measurement context, (b) specification context, and (c) model provenance metadata. These evidence objects are associated with semantic individuals (e.g., defect instances, mechanism instances, parameter-violation instances) but are not used to gate or trigger deterministic rule execution. Causal chain assembly remains deterministic given the instantiated entities, curated causal mapping, and rule base.

In certain embodiments, candidate hypotheses are generated and/or bounded using controlled post-processing of the probabilistic evidence. For example, the system may select one or more defect hypotheses and one or more mechanism hypotheses using a selection criterion derived from the corresponding probability distributions, and may identify a bounded set of candidate parameter-violation hypotheses using a bounding criterion applied to parameter-risk probabilities (e.g., top-K selection, thresholding, adaptive selection, or other selection/bounding criteria). The resulting causal chains are ranked post hoc based on probability values stored in corresponding evidence objects (e.g., terminal parameter risk), producing an RCA packet comprising ranked causal chains together with evidence and provenance pointers.

In some embodiments, corrective-action specifications are associated with root causes or terminal parameter violations and included in the output as prescriptive recommendations, without changing the evidence interface or deterministic causal chain construction.

Other illustrative examples are contemplated including computer-readable media, etc. The foregoing examples broadly outline various aspects, features, and technical advantages of examples according to the disclosure in order that the detailed description that follows may be better understood. It is further appreciated that the above operations described in the context of the illustrative example method, device, and computer-readable medium are not required and that one or more operations may be excluded and/or other additional operations discussed herein may be included. Additional features and advantages will be described hereinafter. The conception and specific examples illustrated and described herein may be readily utilized as a basis for modifying or designing other structures for carrying out the same purposes of the present disclosure. Such equivalent constructions do not depart from the spirit and scope of the appended claims.

### BRIEF DESCRIPTION OF THE DRAWINGS

FIG. 1A is a system diagram illustrating an example computing device and system components for implementing aspects of the uncertainty-aware neurosymbolic pipeline for defect diagnosis described herein.

FIG. 1B is an illustration of an example two-layer uncertainty-aware neurosymbolic architecture (neural evidence layer+deterministic semantic reasoning layer) in which a neural evidence pipeline produces probabilistic evidence that is coupled to a deterministic semantic pipeline via provenance-linked evidence objects.

FIG. 2 is an illustration of an example schema for a conformance-assessment evidence object, including probability value(s), measurement context, specification context, and provenance metadata that associates evidence to instantiated ontology individuals.

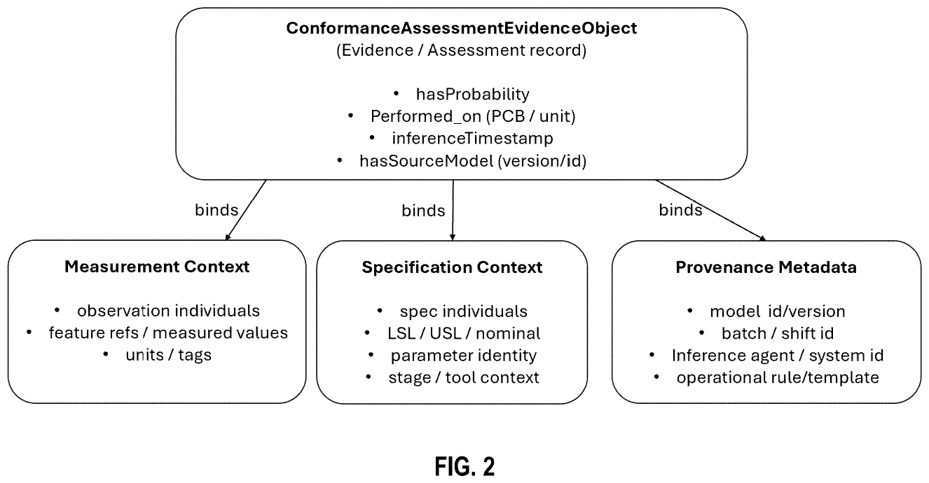

FIG. 3 is an illustration of an example permissible causal mapping (Ishikawa-style adjacency constraints) for a multi-stage SMT defect, showing allowed defect-mechanism-parameter relationships across solder paste printing and solder reflow, and optionally showing inspection evidence links that support mechanism/violation hypotheses.

FIG. 4 is an example method flow including controlled post-processing and configurable hypothesis bounding at an evidence-reasoning interface, semantic instantiation with evidence attachment, deterministic conformance and causal rule execution independent of probability-based rule firing, causal chain construction, post-hoc ranking, and root-cause-analysis (RCA) packet generation.

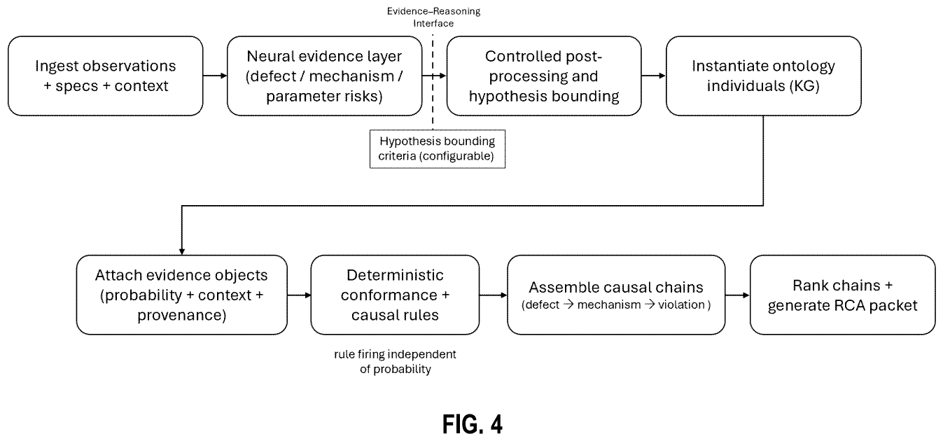

FIG. 5 illustrates an example RCA packet that includes ranked causal chains and associated evidence/provenance pointers suitable for triage, containment, and follow-up investigation.

FIG. 6 is a simplified block diagram of an example process or method associated with the inventive concept described herein.

FIG. 7 is a simplified diagram showing an example neural network architecture model for implementation of aspects described herein.

Corresponding reference characters indicate corresponding elements among the view of the drawings. The headings used in the figures do not limit the scope of the claims.

### DETAILED DESCRIPTION

The present disclosure generally relates to examples and various implementations of a uncertainty-aware neurosymbolic pipeline in which a neural evidence layer estimates defect, stage-wise mechanism, and parameter-risk likelihoods and a deterministic semantic reasoning layer composes and ranks causal chains; with neural outputs being treated as evidence, and not causal claims. In some examples, the neural layer applies controlled post-processing (argmax selection and thresholding) to bound hypothesis enumeration, while the semantic layer instantiates a causal knowledge graph anchored by an Ishikawa-style mapping, attaches provenance-linked conformance assessment evidence objects to instantiated individuals, and deterministically assembles and ranks defect-mechanism-parameter-violation chains by terminal parameter risk. The concept is evaluated on a synthetic multi-shift dataset with correlated variation and graded ground truth, reporting set-level root-cause agreement (hit rate, Jaccard similarity, exact match), triage behavior (mean reciprocal rank), and edge-level chain fidelity with a cycle sanity check.

To summarize, the neural evidence layer can convert manufacturing observations, such as per-board observations into probabilistic evidence for defect class, stage-wise mechanism, and parameter risk, and the deterministic semantic layer then composes causal chains over an explicit Ishikawa-style causal mapping and returns an RCA packet containing ranked hypotheses with evidence and provenance pointers (observation values, specification bounds, timestamps, and model version).

The functions performed in the processes and methods described herein may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

### Overview of System Components

In various embodiments, the disclosed systems include one or more processors and one or more non-transitory memories storing instructions that, when executed, cause the processors to perform operations described herein. The systems may be deployed on-premises in a manufacturing environment, in a private cloud, or in a hybrid configuration, and may integrate with manufacturing execution systems (MES), statistical process control (SPC), advanced process control (APC), quality management systems (QMS), and/or inspection and metrology tools.

### Definitions and Conventions

As used herein, “manufacturing observations” include any measured values, signals, images, metadata, and/or derived features associated with production of a product unit, including process parameters, environmental measurements, metrology results, inspection results, tool logs, and identifiers (e.g., lot, panel, board, wafer, time). “Specification requirements” include target values, nominal values, tolerances, lower specification limits (LSL), and upper specification limits (USL) for parameters and quality characteristics.

“Evidence object” or “conformance-assessment evidence object” refers to a data structure stored in association with a semantic individual (e.g., defect, mechanism, parameter violation) that includes at least: (i) a probability or confidence value, (ii) measurement context, (iii) specification context, and (iv) provenance metadata identifying the producing model and inference context.

“Deterministic” in connection with the semantic reasoning layer refers to causal chain composition and rule execution that does not depend on probabilistic rule firing (i.e., probability values do not control whether a rule inserts edges or individuals). Deterministic reasoning may still ingest evidence objects and attach them for ranking, reporting, and audit.

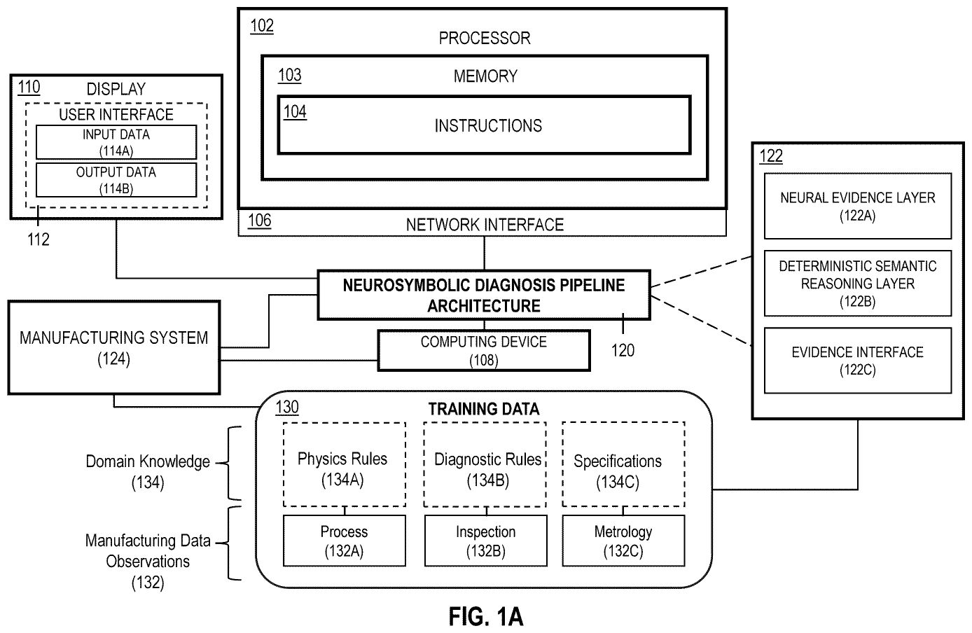

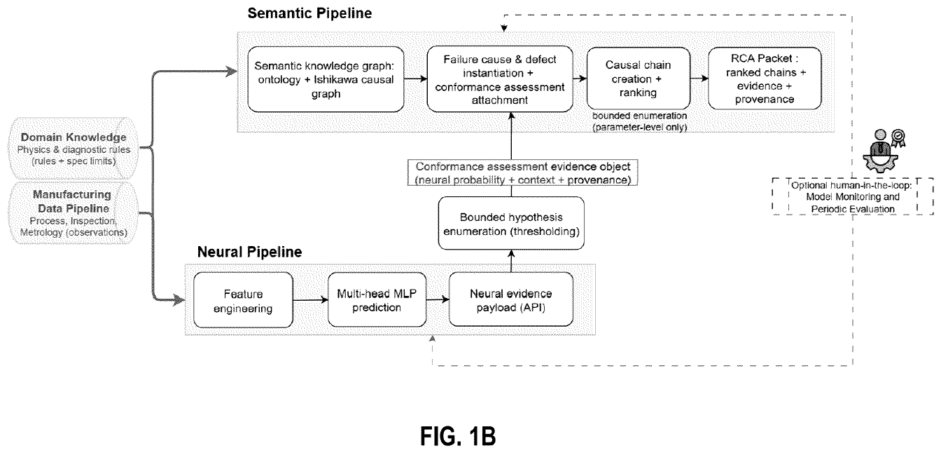

Referring to FIG. 1A, the inventive concept can take the form of a computer-implemented system 100 for neurosymbolic defect diagnosis in a manufacturing process such as semiconductor manufacturing. In the non-limiting example shown, the system 100 includes at least one processor 102, at least one of a memory 103 or storage device storing instructions 104 accessible by the processor 102 that configure the processor 102 for implementing various neurosymbolic defect diagnosis operations and associated functionality described herein. In some examples, the system 100 includes an (end user) computing device 108, that includes or is also in communication with a display 110 that provides access to a user interface (UI) 112 so that a user operating the computing device 108 can provide input data 114A and receive and view output data 114B as further described herein. The system 100 can further include a network interface 106 (or multiple network interfaces), and a bus (or wireless medium) for interconnecting the aforementioned components. The network interface 106 includes the mechanical, electrical, and signaling circuitry for communicating data over links (e.g., wires or wireless links) within a network (e.g., the Internet). The network interface 106 may be configured to transmit and/or receive data using a variety of different communication protocols, as will be understood by those skilled in the art. The aforementioned instructions 104 can be implemented as code and/or machine-executable instructions executable by the processor 102 that may represent one or more of a procedure, a function, a subprogram, a program, a routine, a subroutine, a module, engine, service, an object, a software package, a class, or any combination of instructions, data structures, or program statements, and the like. In other words, the instructions 104 or any operations performed by the processor 102 described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium (e.g., the memory 103), and the processor 102 performs the tasks defined by the code.

In general, the processor 102 is configured, via the instructions 104, to execute aspects of a neurosymbolic diagnosis pipeline architecture 120 and perform various operations to diagnose defects in a manufacturing process of a manufacturing system 124. As indicated, the neurosymbolic diagnosis pipeline architecture 120 includes various services or layers 122 such as a neural evidence layer 122A, a deterministic semantic reasoning layer 122B, and an evidence interface 122C; each of which is further described herein. These layers 122 are non-limiting and other examples of the neurosymbolic diagnosis pipeline architecture 120 can include other services or layers.

As further shown, the layers 122 of the neurosymbolic diagnosis pipeline architecture 120 can be trained with training data 130 including manufacturing data observations 132 and domain knowledge 134. Manufacturing data observations 132 can include, for example, process observations 132A, inspection observations 132B, metrology observations 132C, and the like. Domain knowledge 134 can include physics rules 134A, diagnostic rules 134B, specification rules 134C, and the like. Naturally, as shown, the training data 130 can be derived or mapped from the underlying manufacturing system 124 of interest so that the layers 122 are appropriately trained and tuned.

Input data 114A can include information about the manufacturing system 124, derived from the computing device 108, from a computing element of the manufacturing system 124, or otherwise. Output data 114B generated by the processor 102 can include a ranking of defect-mechanism-parameter-violation chains by terminal parameter risk associated with a process of the manufacturing system 124; i.e., a ranking that can be used for improved defect analysis of the manufacturing system 124.

### Neural Evidence Layer 122A

In an illustrative embodiment, the neural evidence layer 122A includes at least one AI model such as a neural network that receives a per-unit feature vector x derived from manufacturing observations and produces multiple probabilistic outputs. The neural evidence layer 122A may include a shared encoder and multiple task-specific heads.

Defect head: produces a probability distribution over defect classes, such as {NoDefect, OpenCircuit, SolderBridging}, and may be implemented as a softmax head.

Stage-wise mechanism heads: for each modeled stage (e.g., printing, placement, reflow, inspection), produces a probability distribution over mechanism classes for that stage, and may be implemented as softmax heads.

Parameter-risk heads: for each monitored parameter j, produces a risk probability r_j(x) representing likelihood that parameter j is a contributing driver for the predicted defect, and may be implemented as sigmoid heads.

### Controlled Post-Processing and Bounded Hypothesis Enumeration.

To ensure scalability and to prevent combinatorial hypothesis expansion, the system 100 can perform controlled post-processing of the neural evidence layer 122A outputs to produce a bounded set of candidate hypotheses for downstream semantic instantiation and deterministic causal chain construction. In non-limiting embodiments, the system derives one or more defect hypotheses from the defect probability distribution and derives one or more mechanism hypotheses from corresponding stage-wise mechanism probability distributions using one or more configurable hypothesis-selection and/or hypothesis-bounding criteria. Example criteria include, without limitation, maximum-probability selection, top-K selection, threshold-based selection, percentile-based selection, adaptive or context-dependent selection, calibration-informed selection, sampling-based selection, and/or ensemble-based selection. The particular selection and bounding criteria, and the number of hypotheses retained at each level (defect, mechanism, parameter), may be configurable and may vary by deployment, product, stage, or evidence quality.

In further non-limiting embodiments, the system 100 is configured to identify a bounded candidate set V of parameter-violation hypotheses using one or more bounding criteria applied to parameter-risk probabilities and/or related evidence signals, such as selecting a fixed-cardinality set of candidates, applying a threshold or adaptive threshold, applying a percentile rule, applying an uncertainty-aware criterion, and/or applying domain-informed admissibility constraints. The system 100 may enforce one or more limits on hypothesis enumeration (e.g., a maximum number of retained candidates per unit and/or per stage) to maintain predictable runtime and to keep the semantic reasoning layer 122B tractable. In certain embodiments, each selected parameter candidate yields at most one parameter-violation hypothesis per unit, while in other embodiments multiple parameter-violation hypotheses may be retained for a parameter (e.g., corresponding to alternative violation directions or regimes), provided the overall hypothesis set remains bounded.

In some embodiments, the violation direction (e.g., High vs. Low) is determined deterministically using measured values relative to specification bounds and/or nominal values, thereby preserving auditability of how directional nonconformance is inferred. In other embodiments, the violation direction and/or magnitude classification may be derived using rule-based interpretation of measurement context, specification context, and/or additional admissibility constraints, while maintaining the separation between probabilistic evidence generation and deterministic semantic rule execution described herein.

### Deterministic Semantic Reasoning Layer 122B: Semantic Knowledge Graph and Causal Mapping.

The deterministic semantic reasoning layer 122B maintains an ontology-backed knowledge graph that represents domain entities and relations, including products, stages, parameters, specifications, observations, defects, failure causes, mechanisms, and causal relations. The knowledge graph further encodes a curated causal mapping (e.g., Ishikawa-style) that constrains permissible cause-effect relationships, such as which parameter violations may cause which mechanisms and which mechanisms may cause which defects.

The system 100, via the deterministic semantic reasoning layer 122B, instantiates semantic individuals corresponding to at least one selected defect hypothesis, one or more selected mechanism hypotheses (e.g., per modeled stage), and each candidate parameter-violation hypothesis in a bounded candidate set. In some embodiments, the deterministic semantic reasoning layer 122B also instantiates specification individuals and observation individuals and links each observation to a governing specification (e.g., via an isEvaluatedAgainst relationship).

### Evidence Interface 122C: Evidence Objects and Provenance.

For each instantiated semantic individual u (e.g., a defect instance, mechanism instance, or parameter-violation instance), the system creates and associates an evidence object a(u) that stores the probabilistic evidence value produced by the neural evidence layer and provenance metadata.

In one embodiment, an evidence object includes: (i) a probability/confidence value; (ii) a unit identifier (e.g., PCB ID, wafer ID); (iii) a batch/shift identifier; (iv) pointers to the observations and feature context used by the neural model; (v) pointers to the relevant specification individuals (e.g., LSL/USL and nominal values); (vi) a model identifier and version; and (vii) an inference timestamp.

Importantly, the semantic rules for causal chain construction do not consume the probability value to determine whether to insert causal edges or instantiate causes. Instead, rule execution is based on deterministic conditions (e.g., permitted causal adjacency, conformance classifications), while probability values remain attached as auditable evidence to support ranking and reporting.

### Deterministic Causal Chain Construction.

Given the instantiated semantic individuals and the curated causal mapping, the semantic layer constructs one or more causal chains. In an illustrative implementation, causal chains may have the form: Defect→Mechanism→ParameterViolation. The chain construction may be performed by applying deterministic conformance and causal rules implemented as query templates (e.g., SPARQL templates) over the knowledge graph.

In some embodiments, the semantic layer enforces structural constraints such as acyclicity, and limits chains to permitted adjacency relations to avoid spurious links. In some embodiments, the system generates a “root cause” designation for a parameter violation or failure-cause node that has no upstream cause within a defect-specific subgraph.

### Post-Hoc Ranking and RCA Packet Generation.

After causal chains are constructed deterministically, the system ranks the chains post hoc using probability values stored in evidence objects. In one embodiment, the score for a chain is the parameter-risk probability associated with the terminal parameter violation v_j. The system sorts candidate chains by their scores and outputs a ranked list.

The system generates an RCA packet that includes: (i) the predicted defect; (ii) the selected mechanisms; (iii) a ranked list of causal chains; (iv) evidence objects or pointers thereto; and (v) provenance pointers sufficient to trace each ranked hypothesis to supporting observations, specifications, and the producing model outputs.

### Corrective-Action Recommendations (Optional).

In certain embodiments, the system associates corrective-action specifications with one or more semantic individuals, such as root causes, mechanisms, or parameter violations. Corrective-action specifications may be curated from engineering standards, FMEA artifacts, or enterprise troubleshooting knowledge. The system may include such corrective actions in the RCA packet, for example as prescriptive recommendations to adjust process parameters, update a recipe, schedule maintenance, route or hold product, or trigger alerts. In some embodiments, the system can integrate with MES/APC systems to apply changes for subsequent execution of the manufacturing process.

### Example Use Case: SMT Printing and Reflow

In one non-limiting example, the system is applied to SMT assembly for defects including solder bridging and open circuits. Manufacturing observations include printing-stage measurements (e.g., ambient relative humidity, ambient temperature, paste viscosity, stencil thickness) and reflow-stage measurements (e.g., time above liquidus and peak reflow temperature), together with unit identifiers. The neural evidence layer outputs defect probabilities, stage-wise mechanism probabilities for printing and reflow, and parameter-risk probabilities for the monitored parameters. After bounded hypothesis enumeration, the semantic layer constructs candidate causal chains and ranks them based on terminal parameter risk, generating an auditable RCA packet.

### Implementation Details and Computing Environment.

The operations described herein may be implemented by one or more computing devices including processors, memories, network interfaces, and storage, and may be deployed in distributed configurations. Data ingestion may include ETL operations to map staged data into RDF triples and store the knowledge graph in a triple store. Rules may be expressed as declarative query templates (e.g., SPARQL 1.1 UPDATE/CONSTRUCT) and executed to materialize individuals and causal edges. Provenance may be stored using W3C PROV-O or similar representations.

### Alternative Embodiments & Applications

The disclosed systems are not limited to SMT assembly and may be applied to semiconductor wafer fabrication, packaging, test, and other manufacturing contexts. The causal vocabulary may be expanded to additional stages, defects, mechanisms, and parameters. Threshold values, selection methods, and ranking functions may be configurable and may incorporate additional evidence features, while maintaining the separation between probabilistic evidence and deterministic rule execution.

### Example Method & System Architecture

This section describes a study and example implementations of a neurosymbolic pipeline and an evidence interface used to produce auditable RCA artifacts. The design is intentionally asymmetric. The neural pipeline quantifies uncertainty from manufacturing observations and emits probabilistic evidence. Given the instantiated evidence and rule base, the semantic pipeline encodes causal structure and deterministically composes causal chains. Determinism here means that rule execution depends only on instantiated individuals and rule predicates; probabilities are carried as annotations for ranking and audit, not used to trigger rule firing. FIG. 1B summarizes the end-to-end data flow.

### A. Two-Layer Pipeline and Evidence Interface

Let x∈R^{d} denote a per-board feature vector derived from process, inspection, and metrology observations, together with context (e.g., board identifier and batch/shift identifier). The pipeline proceeds in two stages.

Neural evidence layer. A multi-head model produces (i) a defect-class distribution, (ii) a mechanism distribution for each modeled stage, and (iii) per-parameter risk probabilities for the monitored parameters used in hypothesis enumeration. These outputs are interpreted strictly as evidence signals derived from data.

Deterministic semantic reasoning layer. A semantic knowledge graph (ontology plus an Ishikawa-style causal mapping) is instantiated and queried through deterministic conformance and causal rules. The layer constructs causal chains and returns a ranked hypothesis set suitable for triage.

The two layers are coupled through a single boundary artifact: a provenance-linked conformance assessment evidence object. For each instantiated semantic individual (defect, stage mechanism, parameter violation), exactly one conformance assessment binds (i) the probability value, (ii) the measurement or feature context that supports the estimate, and (iii) provenance metadata identifying the producing model version and the inference context. This interface keeps uncertainty explicit and auditable, while allowing symbolic composition to remain deterministic.

### B. Neural Evidence Model

The evidence model is a multi-head feed-forward network with a shared encoder and task-specific heads. Given input x, the shared encoder computes a latent representation h=f_{θ}(x). Heads then produce three classes of outputs.

Defect Head. A Softmax head yields the defect distribution

$$\hat{p} ( y \vert x ) = softmax ( {W}_{y} h + {b}_{y} ) \qquad ( 1 )$$

where y∈{no defect, open circuit, solder bridging}. A single defect class is selected via ŷ=arg max_{y}\hat{p}(y|x) and used as the root node for downstream chain construction.

Stage-wise mechanism heads. For each modeled stage s (printing and reflow in one non-limiting implementation in this study), a softmax head yields

$$\hat{p} ( {m}_{s} \vert x ) = softmax ( {W}_{{m}_{s}} + {b}_{{m}_{s}} ) \qquad ( 2 )$$

where mₛ ranges over the stage-specific mechanism vocabulary, including an explicit no mechanism class. One mechanism per stage is selected via \hat{m}ₛ=argmaxₘ_{ₛ}\hat{p}(mₛ|x).

Parameter risk heads. For each monitored parameter j∈{1, . . . , P}, an independent sigmoid head yields a risk probability

$${\hat{r}}_{j} ( x ) = σ ( {W}_{{r}_{j}} h + {b}_{{r}_{j}} ) . \qquad ( 3 )$$

The reported causal-chain scope of this study is restricted to six process parameters spanning two stages: printing (ambient relative humidity, ambient temperature, paste viscosity, stencil thickness) and reflow (time above liquidus, peak re-flow temperature). In certain example embodiments, the causal-chain vocabulary may include a set of process parameters spanning multiple stages (e.g., printing parameters such as ambient relative humidity, ambient temperature, paste viscosity, stencil thickness, and reflow parameters such as time above liquidus and peak re-flow temperature). In other embodiments, the monitored parameters, stages, and defects may be expanded. The underlying dataset may also contain auxiliary inspection and/or metrology measurements (e.g., solder paste inspection (SPI) paste volume per aperture). Such inspection and metrology measurements may be consumed by the neural evidence model as evidence features and, in some embodiments, may also be represented as terminal candidate causes in causal chains depending on the modeled causal mapping.

The underlying synthetic dataset may also contain auxiliary inspection measurements (e.g., solder paste inspection (SPI) paste volume per aperture). Such inspection measurements are consumed by the neural evidence model as evidence features, but they are not treated as terminal root-cause nodes in the reported causal chains.

### C. Controlled Post-Processing and Bounded Hypothesis Enumeration

The downstream symbolic layer must operate on a bounded hypothesis set. The implementation therefore resolves coarse ambiguity early and preserves uncertainty only where it supports triage.

Defect and mechanism selection. The defect class ŷ and each stage mechanism \hat{m}ₛ are selected by arg max, yielding a single defect-mechanism skeleton for each board.

Parameter violation set. Parameter-level uncertainty is retained as a set of candidate violations obtained through thresholding:

$$v ( x ) = \{ j : {\hat{r}}_{j} ( x ) \geq τ \} \qquad ( 4 )$$

with a fixed threshold τ=0.60 in this study. Hypotheses are enumerated only at the parameter level: each j∈ [symbol] (x) instantiates exactly one candidate causal chain, preventing combinatorial explosion while retaining alternative hypotheses when evidence is ambiguous.

Violation direction. For each selected parameter j∈ [symbol] (x), the violation direction (High/Low) is inferred deterministically from the measured value relative to nominal and the relevant specification limit. Direction is not learned; it is an interpretation of measurement context that remains explicit and auditable.

### D. Semantic Knowledge Graph, Causal Mapping, and Deterministic Reasoning

The semantic pipeline maintains two coupled structures. The first is an ontology that defines the entities required for diagnosis (defect, stage mechanism, parameter, parameter violation, and conformance assessment) and their relations. The second is an Ishikawa-style causal mapping that constrains permissible cause-effect links. In the implemented proof-of-concept, this mapping is represented as a mechanism-parameter adjacency map that is auditable and updatable by engineers, and is also persisted in a graph database to support inspection and querying.

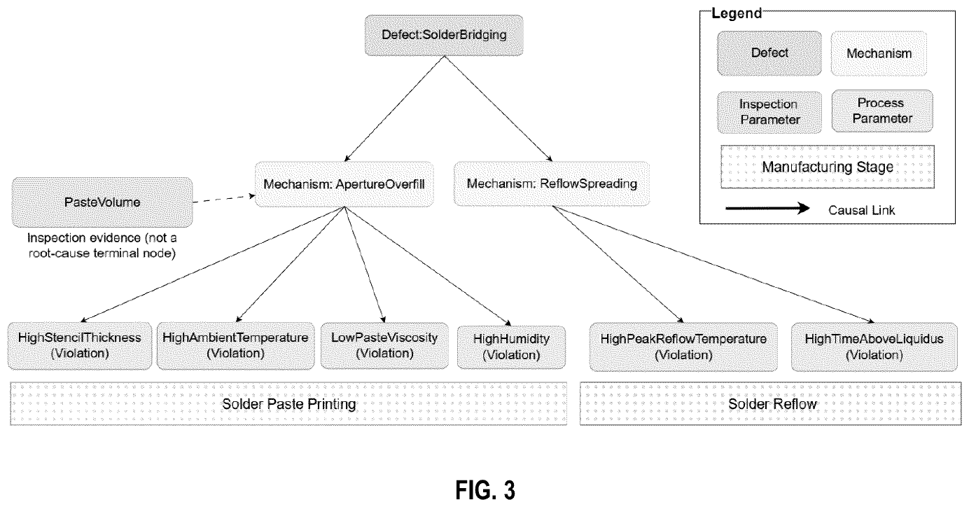

FIG. 3 shows an example Ishikawa-style causal slice linking defects to stage-wise mechanisms and terminal process-parameter violation hypotheses across printing and reflow. In the illustrated example, the dashed edge indicates that solder paste inspection (SPI) paste volume may be treated as inspection evidence supporting mechanism inference rather than as a terminal root-cause node; in other embodiments, inspection measurements may be modeled as terminal candidate causes.

Instantiation and evidence attachment. Given (ŷ, {\hat{m}ₛ}, [symbol] (x)), the system instantiates individuals for the selected defect, the selected mechanisms, and each parameter violation. For each instantiated individual u, exactly one conformance assessment individual a(u) is attached with the following minimum provenance fields:
performed on: printed circuit board (PCB) instance identifier;
hasProbability: probability value output by the corresponding neural head;
hasAssessmentInput: links to the relevant specification individuals (product-level) and observation individuals (PCB-level);
hasSourceModel: producing model version identifier;
contextual identifiers, including batch/shift id (stored on the PCB individual) and inference timestamp.

This evidence object is the boundary artifact that makes the handoff between learning and reasoning explicit.

Deterministic conformance and causal rules. The rule engine applies deterministic rules to (i) assert conformance or non-conformance states, (ii) materialize failure causes and causal links permitted by the causal mapping, and (iii) assemble causal chains of the form

$$Defect \to {Mechanism}_{s} \to {ParameterViolation}_{j} \qquad ( 5 )$$

Probabilities stored in conformance assessment evidence objects are not used to gate rule firing. They remain as annotations to support auditability and downstream ranking.

### E. Causal Chain Construction, Ranking, and RCA Packet

For each parameter violation j∈ [symbol] (x), the semantic layer constructs a causal chain

$${C}_{j} : \hat{y} \to {\hat{m}}_{s ( j )} \to {v}_{j} \qquad ( 6 )$$

where vⱼ denotes the instantiated parameter-violation individual and s(j) denotes its associated stage. Chains are ranked by the terminal parameter risk probability stored in the corresponding evidence object,

$$score ( {C}_{j} ) = {\hat{r}}_{j} ( x ) . \qquad ( 7 )$$

The resulting RCA packet contains (i) the ranked chain list, (ii) the associated conformance assessment evidence objects (probabilities), and (iii) provenance pointers sufficient to trace each hypothesis back to its originating observations and model outputs. Corrective-action recommendation is contemplated and can be associated with a given causal chain in the ranked chain list. Human-in-the-loop model monitoring and periodic evaluation can be treated as offline processes and are not required for online inference (FIG. 1B).

### F. Didactic Pairing and Extensibility

To keep the causal vocabulary compact while making the evidence interface concrete, this study focuses on two stages and two representative defects. Several monitored parameters appear with opposite non-compliance directions across solder bridging and open circuit to make the role of directionality explicit in hypothesis generation. This pairing is didactic rather than a methodological constraint. Extending the approach to additional defects, mechanisms, and process parameters requires expanding the causal mapping and rule catalog; the evidence interface, deterministic chain construction, and ranking procedure remain unchanged.

### Experimental Design

This section describes the synthetic dataset design, the train-validation-test protocol, and the end-to-end evaluation procedure for the proposed neurosymbolic RCA pipeline. An evaluation is made under (i) cross-parameter correlation and (ii) batch/shift separation to prevent leakage.

### A. Synthetic Dataset Generation with Correlated Variation and Temporal Structure

In an example implementation, per-board records may be generated using a synthetic generator that combines correlated sampling with temporal structure. Correlations across variables may be produced via a Gaussian-copula construction with a nearest positive-definite correction. Non-stationarity may be introduced through stencil-thickness wear with periodic replacement and a diurnal ambient-temperature cycle. Multi-batch datasets may be emitted as batch/shift-like groups with different random seeds and start-hour offsets.

In this example, the reported scope is restricted to six process parameters spanning two stages:
Solder paste printing: ambient relative humidity, ambient temperature, paste viscosity, stencil thickness; and
Solder reflow: time above liquidus, peak reflow temperature.

The underlying synthetic dataset also contains auxiliary inspection measurements used as evidence features (e.g., solder paste inspection paste volume per aperture). The causal chains and all reported RCA metrics are computed over the six process parameters listed above.

### B. Ground-Truth Defect, Mechanism, and Graded Parameter Risk

Each synthetic record is assigned (i) a defect label, (ii) a stage-wise mechanism label for printing and reflow, and (iii) graded relevance for parameter violations. Defect classification is trained and evaluated as a three-class task over {no defect, open circuit, solder bridging}. Mechanism labels are stage-wise and include an explicit no mechanism class per stage. For the printing stage, mechanism ground truth is limited to aperture overfill and poor paste transfer (plus no mechanism). There is no introduction of explicit paste-volume violation labels as terminal causal nodes in the reported causal chains.

To support triage-centric ranking metrics, ground truth for parameter violations is graded rather than binary. During synthetic ground-truth generation, each monitored parameter is assigned a risk probability by a mapping that (i) remains near a low baseline in a safe region, (ii) increases smoothly as the value approaches the relevant specification limit, and (iii) rises asymptotically beyond the limit while remaining bounded away from {0, 1}. Let Δⱼ denote a signed deviation for parameter j in the relevant direction (High or Low), and let Δ_{j,1} and Δ_{j,2} denote two deviation thresholds that partition the safe, transition, and out-of-spec regions. The ground-truth risk probability is

$${P}_{j}^{gt} ( {Δ}_{j} ) = {p}_{L} + ( {p}_{M} - {p}_{L} ) {z}_{j}^{2} + ( {p}_{H} - {p}_{M} ) ( 1 - {e}^{- {Kt}_{j}} ) \qquad ( 8 )$$

$${z}_{j} = min ( 1 , max ( 0 , \frac{\vert {Δ}_{j} \vert - {Δ}_{j , 1}}{{Δ}_{j , 2} - {Δ}_{j , 1}} ) ) \qquad ( 9 )$$

$${t}_{j} = max ( 0 , \vert {Δ}_{j} \vert - {Δ}_{j , 2} ) \qquad ( 10 )$$

where zⱼ∈[0,1] clips the normalized deviation to the transition region and tⱼ captures the out-of-spec exceedance beyond Δ_{j,2}. Here p_{L}, pₘ, and p_{H} denote the low-, mid-, and high-risk probability levels (with 0<p_{L}<pₘ<p_{H}<1), and [symbol] >0 controls the out-of-spec rise rate. In our generator, the mapping is parameterized to reflect a conservative risk prior (baseline near 0.05 in the safe region, rising to ≈0.70 at the specification limit, and asymptotically approaching 0.99 out of spec). At inference time, the pipeline uses MLP-predicted probabilities as evidence for ranking; the risk mapping in (8) need not be used online.

Because defect classes are imbalanced, per-class precision/recall and a weighted-average F1-score were reported in addition to overall accuracy.

### C. Batch-Level Splitting to Prevent Leakage

Train-validation-test splits are performed at the batch/shift level to prevent leakage induced by correlated drift and within-batch structure. All records from a given batch identifier are assigned to exactly one of train, validation, or test. Feature transformations (e.g., normalization) are fit on the training split only and then applied to validation and test splits. This protocol prevents the model from exploiting batch-local patterns that would not be available when diagnosing previously unseen shifts.

### D. Neural Training and Inference Protocol

The neural evidence model may be trained on historical and/or synthetic datasets to predict defect class, stage-wise mechanisms, and per-parameter risk probabilities. Model selection may use validation performance. At inference time, the model produces defect and mechanism distributions and per-parameter risk probabilities for each product unit. Coarse ambiguity may be resolved using configurable defect and mechanism hypothesis-selection criteria (e.g., maximum-probability selection, top-K selection, thresholding, sampling, ensemble-based selection, or combinations thereof). Parameter-level uncertainty may be retained through configurable hypothesis-bounding criteria (e.g., thresholding set at a fixed ‘r (set to ‘r=0.60 in this study), top-K, percentile rules, adaptive selection) to define a bounded set of candidate parameter-violation hypotheses that are instantiated in the semantic layer.

### E. Semantic Instantiation, Causal Chain Construction, and Ranking

TABLE I
Dataset and Label Schema (summary)

| Item | Value |
|---|---|
| Defect Classes | No defect; open circuit; solder |
| | bridging |
| Stages modeled | Solder past printing; solder reflow |
| Printing mechanisms | Aperture overfill; poor paste transfer; |
| | no mechanism |
| Reflow mechanisms | Reflow spreading; non-coalescence; |
| | no mechanism |
| Terminal process parameters | Ambient RH; ambient temperature; |
| | paste viscosity; stencil thickness; |
| | time above liquidus; peak reflow |
| | temperature |
| Split protocol | Batch/shift-level grouped split |
| Threshold τ | 0.60 |
| Dataset size | N = 200,000; train/val/test = |
| | 140,000/30,000/30,000 |
| Class distribution | No defect: 175,420; solder bridging: |
| | 12,569; open circuit: 12,011 |

For each test instance, the semantic pipeline instantiates individuals for the selected defect hypothesis, selected mechanism hypotheses, and each retained parameter-violation hypothesis. Each instantiated individual may be annotated with a provenance-linked conformance assessment that stores the relevant probability or confidence value, the assessment inputs (specification and observation individuals), the producing model version, and context identifiers (PCB id and batch/shift id). Deterministic conformance and causal rules materialize failure causes and causal links permitted by an Ishikawa-style causal mapping. The pipeline then constructs defect-mechanism-parameter-violation chains and ranks them by a corresponding evidence value (e.g., terminal parameter risk probability) stored in the corresponding evidence object. The resulting RCA packet contains ranked chains together with evidence and provenance pointers; in some embodiments, corrective-action specifications may also be attached as described herein. Table I summarizes the dataset and label schema used in evaluation.

### Metrics and Results

This section defines the evaluation metrics used to assess triage-oriented causal diagnosis and reports results for the end-to-end neurosymbolic pipeline. (i) Defect-level predictive performance was reported to contextualize evidence quality, and (ii) causal reasoning metrics that evaluate set-level correctness, triage behavior, and structural validity of the inferred diagnostic artifact were also reported.

### A. Defect Prediction Metrics

The defect head was trained and evaluated as a three-class classifier over {no defect, open circuit, solder bridging}. Under class imbalance, the defect-screening performance was summarized using overall accuracy and weighted-average F1-score.

On the held-out test split, the defect head achieved 95.00% accuracy and 95.36% weighted-average F1-score.

### B. For Each PCB, the Neurosymbolic Pipeline Produced a Set of Predicted Root Causes and an Ordered (Ranked) List of Causal-Chain Hypotheses. The Set-Level Correctness and Triage Behavior was Evaluated as Follows

Hit rate (≥1 correct). We report hit rate as a coverage metric indicating whether the predicted root-cause set contains at least one ground-truth root cause. For PCB i, let:

$${ℛ}_{i}^{gt}$$

denote the set of ground-truth root causes and [symbol] denote the set of predicted root causes produced by the semantic pipeline. A hit occurs when

$${ℛ}_{i}^{gt} ∩ {\hat{ℛ}}_{i} \neq ∅ ,$$

and the aggregate hit rate is:

$$HitRate = \frac{1}{N} {\sum }_{i = 1}^{N} 𝕀 ( {ℛ}_{i}^{gt} ∩ {\hat{ℛ}}_{i} \neq ∅ ) , \qquad ( 11 )$$

where N is the number of test instances and Π(⋅) is the indicator function.

Exact match. Exact match is the fraction of instances for which the predicted root-cause set equals the ground-truth root-cause set.

Jaccard similarity. Jaccard similarity measures set overlap between predicted and ground-truth root-cause sets, averaged across instances.

MRR. Mean reciprocal rank (MRR) captures how early the dominant ground-truth cause is surfaced in the ranked hypothesis list. For each PCB, we define the dominant ground-truth cause as the one whose terminal parameter violation has the highest ground-truth risk probability. Let

$${rank}_{j}^{*}$$

be the rank position of the corresponding predicted hypothesis in the ordered list. Then

$$MRR = \frac{1}{N} {\sum }_{i = 1}^{N} \frac{1}{{rank}_{i}^{*}} . \qquad ( 12 )$$

### C. Chain Fidelity and Structural Sanity Metrics

Set metrics alone are insufficient if the produced diagnostic artifact contains malformed causal structure. Therefore, fidelity and sanity metrics were reported that evaluate the validity of inferred causal relations.

Chain precision and recall. The edge-level chain precision and recall was computed by comparing predicted defect→mechanism and mechanism→parameter-violation edges to the corresponding ground-truth edges, micro-averaged across instances.

Cycle sanity check. Whether any cycles are detected in the inferred causal graph was reported as a structural sanity check.

### D. Results

Table II summarizes end-to-end neurosymbolic performance on the held-out test split. Hit rate (≥1 correct) is 77.20%. Set agreement between predicted and ground-truth root-cause sets is 69.75% Jaccard similarity and 62.60% exact match. Mean reciprocal rank is 0.71, so the dominant ground-truth cause typically appears near the top of the ranked hypotheses. Edge-level chain fidelity is 92.17% precision and 86.05% recall, with no cycles detected.

TABLE II
Neurosymbolic RCA performance on the held-out test split, reporting
set-level agreement, triage behavior, and edge-level fidelity.

| Metric | Value |
|---|---|
| Hit rate (≥1 correct) | 77.20% |
| Jaccard similarity | 69.75% |
| Exact match accuracy | 62.60% |
| MRR | 0.71 |
| Chain precision | 92.17% |
| Chain recall | 86.05% |
| Cycle check | None detected |

### Qualitative Example and Discussion

Quantitative metrics summarize triage behavior in aggregate, but they do not convey what the system returns to an engineer at the moment of diagnosis. Therefore, a qualitative example was included of an RCA packet—the auditable diagnostic artifact produced for a single PCB instance. The packet contains the predicted defect and stage-wise mechanisms, a ranked list of causal hypotheses, and provenance pointers that trace each hypothesis to its supporting evidence (observation values, specification limits, assessment timestamp, and model version).

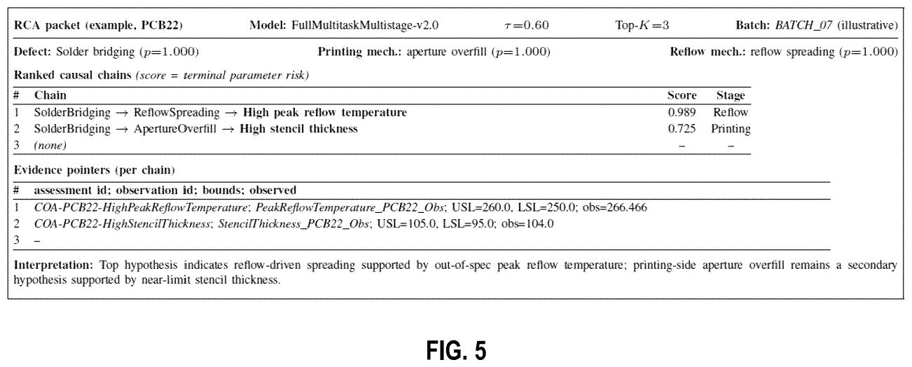

FIG. 5 shows an illustrative RCA packet rendered from the knowledge graph for a representative test instance (PCB22). The system predicts solder bridging and returns ranked hypotheses spanning both stages. The top hypothesis attributes the defect to a reflow spreading mechanism supported by an out-of-spec peak reflow temperature, while a secondary hypothesis identifies a printing-side aperture overfill mechanism supported by near-limit stencil thickness. Each hypothesis is accompanied by an assessment identifier and observation identifier, together with observed values and specification bounds, enabling audit and follow-up investigation.

In practice, two properties make the RCA packet usable. First, it separates evidence from causality: probabilities remain provenance-linked annotations, while chain construction is deterministic given the instantiated evidence and rule base. Second, it supports triage by surfacing the most supported hypothesis first while retaining alternatives when the evidence is ambiguous.

### Further Discussion & Examples

The above study evaluates an uncertainty-aware neurosymbolic RCA pipeline through a deliberately constrained causal vocabulary and a synthetic dataset designed to emulate correlated variation and batch/shift structure. These choices support a controlled, auditable study of the evidence interface and triage behavior, but they introduce limitations that also suggest clear extensions.

Synthetic setting. The evaluation uses synthetic data and therefore cannot capture all real-world confounders, drift modes, and measurement idiosyncrasies present in high-volume manufacturing. The primary value of the synthetic setting is that it provides known ground truth for defect, mechanism, and graded parameter risk, enabling unambiguous assessment of ranked causal hypotheses.

Scope of defects, stages, and parameters. The study focuses on two stages (printing and reflow), two representative defect types, and a compact set of six process parameters. We limit the defect and mechanism vocabulary and the number of monitored parameters to keep the evidence interface and ranking behavior inspectable.

Dependence on a curated causal mapping. The semantic layer relies on an explicit Ishikawa-style causal mapping and rule catalog. This is a design choice in service of auditability. It also implies that coverage is bounded by the modeled vocabulary and relations; missing mechanisms or missing rules will limit diagnostic completeness.

Threshold-driven hypothesis set. Because hypothesis enumeration is threshold-driven, overly strict thresholds can over-prune candidate causes and reduce coverage, while moderate thresholds preserve triage behavior.

Vocabulary expansion without interface change. Extending the method to additional defects, mechanisms, stages, and parameters requires expanding the causal graph and rule catalog. The evidence interface (provenance-linked conformance assessment objects) and the ranking procedure remain unchanged.

Industrial validation and multimodal evidence. A key next step is to validate the pipeline on industrial datasets that include inspection, metrology, and process logs. This also enables incorporating additional evidence modalities, such as automated optical inspection (AOI) and solder paste inspection (SPI) images, as well as tool traces, through the neural evidence layer while retaining the same symbolic composition and audit artifacts.

Calibration and robustness under drift. Because probabilities are used for ranking, future work will evaluate post-hoc calibration methods and drift-aware monitoring strategies. The goal is to preserve probability trustworthiness as process conditions shift, while keeping the semantic layer deterministic and auditable.

Action attachment and closed-loop workflows. Corrective-action recommendation is contemplated. In some embodiments, the evidence interface supports attaching corrective-action knowledge to inferred causes and integrating human-in-the-loop confirmation, monitoring, and/or learning updates without changing the causal chain construction semantics. The same interface supports attaching action knowledge to inferred causes and integrating human-in-the-loop confirmation and learning updates without changing the causal chain construction semantics.

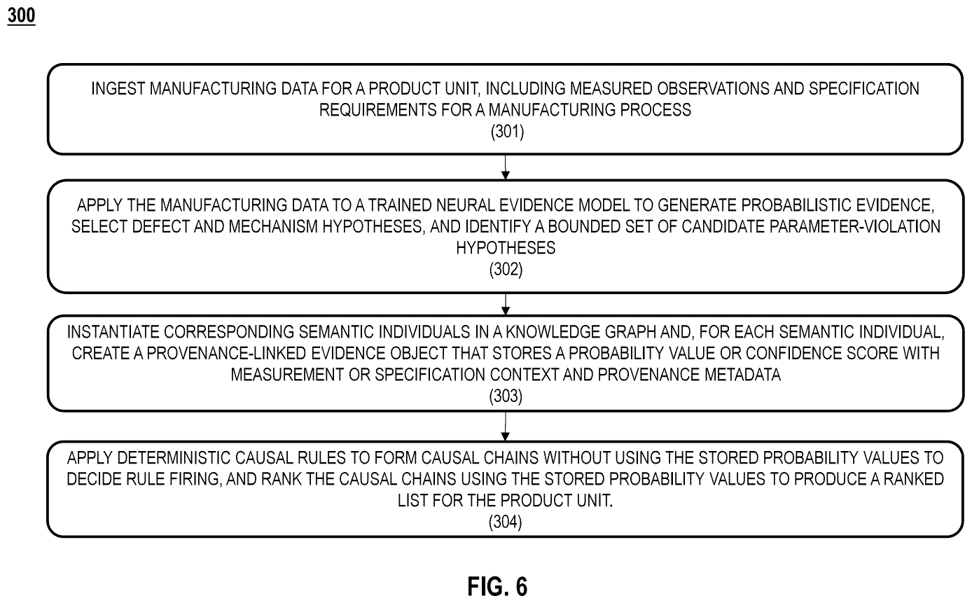

Referring to FIG. 6, a simplified block diagram of an example non-limiting method or process 300 associated with the neurosymbolic defect diagnosis aspects described herein is shown. In some embodiments, process 300 is performed by the system 100 of FIG. 1A; via the processor 102 executing instructions 104, or otherwise. In general, the process 300 incorporates an uncertainty-aware neurosymbolic approach to root-cause analysis in surface-mount assembly designed for triage and auditability. A neural evidence layer converts manufacturing observations into probabilistic evidence, while a deterministic semantic layer composes defect-mechanism-parameter-violation causal chains over an Ishikawa-style causal mapping and ranks hypotheses using provenance-linked conformance assessment evidence objects. The resulting RCA packet provides ranked hypotheses with evidence and provenance pointers sufficient for verification and post-mortem review. Quantitative results demonstrate strong set-level agreement and triage behavior while maintaining high edge-level fidelity and a cycle sanity check.

Referring to block 301 of process 300, at least one processor ingests manufacturing data for a product unit. The manufacturing data includes measured observations collected from the manufacturing process and specification requirements applicable to the product unit, such as limits, targets, or tolerance bands.

In block 302, the processor applies the manufacturing data as input to a trained neural evidence model to generate probabilistic evidence. The probabilistic evidence includes a defect probability distribution, at least one stage-wise mechanism probability distribution, and parameter-risk probabilities. Using that probabilistic evidence, the processor selects at least one defect hypothesis and at least one mechanism hypothesis and identifies a bounded set of candidate parameter-violation hypotheses based on the parameter-risk probabilities.

Referring to block 303, the processor instantiates, in a knowledge graph, semantic individuals corresponding to the selected defect hypothesis, the selected mechanism hypothesis, and the bounded set of candidate parameter-violation hypotheses. For each instantiated semantic individual, the processor creates a provenance-linked evidence object that stores a probability value or confidence score derived from the probabilistic evidence and associates that value with measurement context or specification context, along with provenance metadata identifying the neural evidence model and an inference context.

In block 304, the processor executes deterministic causal rules in view of the knowledge graph to connect at least one defect hypothesis to at least one candidate parameter-violation hypothesis through at least one mechanism hypothesis, thereby forming a plurality of causal chains. The deterministic causal rules do not use the stored probability values or confidence scores to determine whether to form the causal chains. The processor then ranks the plurality of causal chains based on the stored probability values in the provenance-linked evidence objects to produce an output comprising a ranked list of causal chains for the product unit.

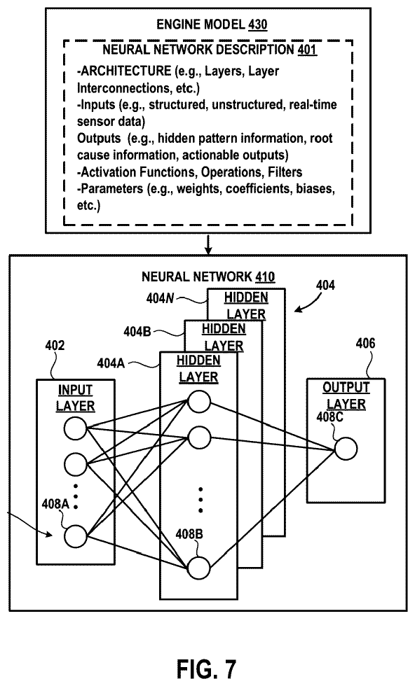

FIG. 7 is a schematic block diagram showing a simplified example of a neural network architecture 400 that may be used with one or more embodiments described herein. Neural network architecture 400 can be implemented using any processing elements or computing devices described herein, as part of Deep Learning Neurosymbolic Framework processes/services 390.

Architecture 400 includes a neural network 410 defined by an example neural network description 401 in an engine model (neural controller) 430. The neural network description 401 can include a full specification of the neural network 410, including the neural network architecture 400. For example, the neural network description 401 can include a description or specification of the architecture 400 of the neural network 410 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 410 reflects the architecture 400 defined in the neural network description 401. The neural network 410 includes an input layer 402, which includes multimodal input data, such as structured, unstructured, and real-time inputs (e.g., imaging data for semiconductors, patient health data, supply chain operations data, etc.). Individual “pieces” of data can correspond to one or more nodes 408.

The neural network 410 includes hidden layers 404A through 404N (collectively “404” hereinafter). The hidden layers 404 can include one or more hidden layers, selected based on a desired processing outcome. The neural network 410 further includes an output layer 406 that provides an output (e.g., defect class probabilities, mechanism probabilities, parameter-risk probabilities, hidden pattern information, root cause information, and/or actionable output(s)) resulting from the processing performed by the hidden layers 404.

The neural network 410 in this example can be a multi-layer neural network of interconnected nodes. Each node can represent a piece of information. Information associated with the nodes is shared among the different layers and each layer retains information as information is processed. In some cases, the neural network 410 can include a feed-forward neural network, in which case there are no feedback connections where outputs of the neural network are fed back into itself. In other cases, the neural network 410 can include a recurrent neural network, which can have loops that allow information to be carried across nodes while reading in input.

Information can be exchanged between nodes through node-to-node interconnections between the various layers. Nodes of the input layer 402 can activate a set of nodes in the first hidden layer 404A. For example, as shown, each of the input nodes of the input layer 402 is connected to each of the nodes of the first hidden layer 404A. The nodes of the hidden layer 404A can transform the information of each input node by applying activation functions to the information. The information derived from the transformation can then be passed to and can activate the nodes of the next hidden layer (e.g., 404B), which can perform their own designated functions. Example functions include convolutional, up-sampling, data transformation, pooling, and/or any other suitable functions. The output of the hidden layer (e.g., 404B) can then activate nodes of the next hidden layer (e.g., 404N), and so on. The output of the last hidden layer can activate one or more nodes of the output layer 406, at which point an output is provided. In some cases, while nodes (e.g., nodes 408A, 408B, 408C) in the neural network 410 are shown as having multiple output lines, a node has a single output and all lines shown as being output from a node represent the same output value.

In some cases, each node or interconnection between nodes can have a weight that is a set of parameters derived from training the neural network 410. For example, an interconnection between nodes can represent a piece of information learned about the interconnected nodes. The interconnection can have a numeric weight that can be tuned (e.g., based on a training dataset, which may include expert-provided data), allowing the neural network 410 to be adaptive to inputs and able to learn as more data is processed.

The neural network 410 can be pre-trained to process the features from the data in the input layer 402 using the different hidden layers 404 in order to provide the output through the output layer 406. In an example, the neural network 410 can be trained using training data that includes example mappings between multimodal input data and hidden pattern information, root cause information, actionable output(s), etc. Training data can be input into the neural network 410, which can be processed by the neural network 410 to generate outputs which can be used to tune one or more aspects of the neural network 410, such as weights, biases, etc.

In some cases, the neural network 410 can adjust weights of nodes using a training process such as backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for the neural network 410, the output can include values that do not give preference to any particular class due to the weights being randomly selected at initialization. With the initial weights, the neural network 410 may be unable to generate precisely correct information. A loss function can be used to analyze errors in the output. Any suitable loss function definition can be used.

The loss (or error) can be high for the first training dataset (e.g., images) since the actual values will be different than the predicted output. The goal of training is to minimize the amount of loss so that the predicted output comports with a target or ideal output. The neural network 410 can perform a backward pass by determining which inputs (weights) most contributed to the loss of the neural network 410, and can adjust the weights so that the loss decreases and is eventually minimized.

A derivative of the loss with respect to the weights can be computed to determine the weights that contributed most to the loss of the neural network 410. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 410 can include any suitable neural or deep learning network. One example includes a graph neural network. In other examples, the neural network 410 can represent or otherwise incorporate aspects of other types of neural or deep learning networks or artificial intelligence, such as an autoencoder, a convolutional neural network (CNN), a deep belief nets (DBNs), and recurrent neural networks (RNNs), classifier(s), discriminator(s), generative adversarial networks, large language models (LLMs), transformer networks, etc.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A computer-implemented method for neurosymbolic defect diagnosis in manufacturing, comprising:
ingesting, by at least one processor, manufacturing data for a product unit, the manufacturing data comprising measured observations and specification requirements for a manufacturing process;
applying, by the at least one processor, the manufacturing data as input to a trained neural evidence model to generate probabilistic evidence including (i) a defect probability distribution, (ii) at least one stage-wise mechanism probability distribution, and (iii) a plurality of parameter-risk probabilities;
selecting, based on the probabilistic evidence, (i) at least one defect hypothesis and (ii) at least one mechanism hypothesis;
identifying, based on the plurality of parameter-risk probabilities, a bounded set of candidate parameter-violation hypotheses;
instantiating, in a knowledge graph, semantic individuals corresponding to at least one defect hypothesis, at least one mechanism hypothesis, and the bounded set of candidate parameter-violation hypotheses;
creating, for each instantiated semantic individual, a provenance-linked evidence object that stores at least a probabilistic value or confidence score derived from the probabilistic evidence and associates the probabilistic value or confidence score with at least one of (a) measurement context or (b) specification context, and provenance metadata identifying the trained neural evidence model and an inference context;
executing, in view of the knowledge graph, one or more deterministic causal rules that connect at least one defect hypothesis to at least one candidate parameter-violation hypothesis through at least one mechanism hypothesis to form a plurality of causal chains, wherein the one or more deterministic causal rules do not use the probability values or confidence scores stored in the provenance-linked evidence objects to determine whether to form the plurality of causal chains; and
ranking the plurality of causal chains based on the probability values stored in the provenance-linked evidence objects to produce an output comprising a ranked list of causal chains for the product unit.

2. The computer-implemented method of claim 1, wherein the trained neural evidence model comprises a shared encoder configured to generate a latent representation from the manufacturing data and a plurality of task-specific heads configured to output the defect probability distribution, the at least one stage-wise mechanism probability distribution, and the plurality of parameter-risk probabilities.

3. The computer-implemented method of claim 1, wherein selecting the at least one defect hypothesis comprises applying at least one configurable hypothesis-selection criterion to the defect probability distribution to retain a set of candidate defect hypotheses.

4. The computer-implemented method of claim 1, wherein selecting the at least one mechanism hypothesis comprises, for at least one modeled stage, applying at least one configurable hypothesis-selection criterion to the corresponding stage-wise mechanism probability distribution to retain a set of candidate mechanism hypotheses for the modeled stage.

5. The computer-implemented method of claim 1, wherein identifying the bounded set of candidate parameter-violation hypotheses comprises applying at least one configurable hypothesis-bounding criterion to the parameter-risk probabilities to retain a bounded candidate set, and wherein the hypothesis-bounding criterion comprises at least one of fixed-cardinality selection, threshold-based selection, percentile-based selection, adaptive selection, uncertainty-aware selection, calibration-informed selection, sampling-based selection, or ensemble-based selection.

6. The computer-implemented method of claim 1, further comprising determining, for at least one candidate parameter-violation hypothesis, a violation direction based on a measured value relative to at least one of a nominal value, a lower specification limit, or an upper specification limit.

7. The computer-implemented method of claim 1, wherein the knowledge graph represents products, manufacturing stages, parameters, specifications, observations, defects, mechanisms, and causal relations.

8. The computer-implemented method of claim 1, wherein executing the one or more deterministic causal rules comprises enforcing a curated causal adjacency map that restricts permissible parameter-to-mechanism relationships and mechanism-to-defect relationships.

9. The computer-implemented method of claim 1, wherein each provenance-linked evidence object includes a product-unit identifier, a probability value or confidence score, specification context, observation context, a model identifier and model version for the trained neural evidence model, and an inference timestamp.

10. The computer-implemented method of claim 1, wherein the ranked list of causal chains further includes provenance pointers sufficient to trace each causal chain to supporting measured observations and specification requirements in the manufacturing data.

11. The computer-implemented method of claim 1, wherein ranking the plurality of causal chains comprises scoring each causal chain using a terminal parameter-risk probability associated with a parameter-violation hypothesis at a terminal end of the causal chain.

12. The computer-implemented method of claim 1, wherein the ranked list of causal chains and the provenance-linked evidence objects together form a root-cause analysis packet for the product unit.

13. The computer-implemented method of claim 1, further comprising evaluating calibration of at least one probability output by the trained neural evidence model and storing a calibration metric in association with the trained neural evidence model.

14. The computer-implemented method of claim 1, further comprising associating at least one corrective-action specification with at least one of a defect hypothesis, a mechanism hypothesis, or a candidate parameter-violation hypothesis, and including the corrective-action specification with the ranked list of causal chains.

15. The computer-implemented method of claim 1, wherein the corrective-action specification prescribes at least one process change selected from updating a process recipe, scheduling maintenance, generating a process-control alert, routing the product unit, or holding the product unit.

16. The computer-implemented method of claim 1, wherein the manufacturing process comprises semiconductor manufacturing or electronics assembly and the product unit comprises at least one of a printed circuit board, a package, a wafer, or a die.

17. A system for defect diagnosis using neurosymbolic techniques, comprising:
a processor and memory storing instructions that, when executed by the processor, cause the processor to implement a neurosymbolic diagnosis pipeline comprising a neural layer and a semantic reasoning layer integrated via a conformance assessment interface, wherein the processor:
ingests manufacturing data associated with a manufacturing process;
implements the neural layer to quantify uncertainty from manufacturing observations defined in the manufacturing data to output, from the neural layer, probabilistic evidence signals including probability values associated with aspects of the manufacturing process;
executes the semantic reasoning layer to instantiate semantic individuals for domain knowledge associated with the manufacturing process;
creates for each of the semantic individuals, a provenance-linked evidence object that binds at least one probability value or confidence score to measurement context, specification context, and provenance metadata associated with the neural layer;
forms a plurality of causal chains given the semantic individuals and in view of one or more deterministic causal rules, wherein the one or more deterministic causal rules do not use the probability values stored in the provenance-linked evidence objects to determine whether to form the plurality of causal chains; and
ranks the plurality of causal chains based on the probability values stored in a respective provenance-linked evidence object to produce an output comprising a ranked list of causal chains configured for diagnosing the manufacturing process.

18. The system of claim 17, wherein the probabilistic evidence signals comprise a defect probability distribution, at least one stage-wise mechanism probability distribution, and a plurality of parameter-risk probabilities, and wherein the processor selects at least one defect hypothesis and at least one mechanism hypothesis and identifies a bounded set of candidate parameter-violation hypotheses based on the probabilistic evidence signal.

19. The system of claim 17, wherein the conformance assessment interface provides exactly one provenance-linked evidence object for each semantic individual representing a defect, a stage mechanism, or a parameter violation, and wherein each provenance-linked evidence object includes at least a product-unit identifier, a probability value or confidence score, supporting measurement context, supporting specification context, a model identifier and model version, and an inference timestamp.

20. A non-transitory computer-readable medium storing instructions that, when executed by one or more processors, cause the one or more processors to:
ingest data associated with a manufacturing process;
quantify, by a neural layer, uncertainty from manufacturing observations defined in the manufacturing data to output probabilistic evidence signals including probability values associated with aspects of the manufacturing process;
instantiate, by a semantic reasoning layer, semantic individuals for domain knowledge associated with the manufacturing process;
create, for each of the semantic individuals, a provenance-linked evidence object that binds at least one probability value or confidence score to measurement context, specification context, and provenance metadata associated with the neural layer;
form a plurality of causal chains given the semantic individuals and in view of one or more deterministic causal rules, wherein the one or more deterministic causal rules do not use the probability values stored in the provenance-linked evidence objects to determine whether to form the plurality of causal chains; and
rank the plurality of causal chains based on the probability values stored in a respective provenance-linked evidence object to produce a ranked list of causal chains configured for diagnosing the manufacturing process.
